(19) United States
(12) Patent Application Publication
(10) Pub. No.: US 2008/0235688 A1
(43) Pub. Date: Sep. 25, 2008

(54) Enhanced Distance Calculation for Job Route Optimization

(75) Inventors: James T. Panttaja, Healdsburg, CA (US); Jonathan Lange, Katy, TX (US)

Correspondence Address: FENWICK & WEST LLP, SILICON VALLEY CENTER, 801 CALIFORNIA STREET, MOUNTAIN VIEW, CA, 94041, US

(73) Assignee: SAPIAS, INC., San Francisco, CA (US)

(21) Appl. No.: 11/689,016

(22) Filed: Mar. 21, 2007

(51) Int. Cl. G06F 9/46

(52) U.S. Cl. 718/102; 705/8

(57) ABSTRACT

Systems and methods provide optimized distribution of jobs for execution among available workers. Categories are established for pairs of jobs based on a precise or estimated distance between each pair of jobs. Values are then assigned to the pairs of jobs and various decisions about job assignment and grouping can be made based upon the assigned value. The systems and methods allow certain job pairs to be excluded from consideration from grouping together, and emphasize which jobs are best suited for pairwise assignment, resulting in reduction of costs and necessary resources.

### RELATED APPLICATIONS

This application is related to co-pending U.S. application Ser. No. 10/412,594, entitled “Asset Management Platform,” filed on Apr. 8, 2003, which is hereby incorporated by reference in its entirety.

### BACKGROUND

1. Field of the Invention

The present invention relates generally to distribution of jobs for execution among multiple workers, and more specifically, to optimizing distribution of jobs considering geographical limitations.

2. Description of the Related Art

Many enterprises, such as business and government agencies, rely on a set of widely-distributed assets in order to conduct business. For example, a delivery service uses a fleet of trucks to make deliveries. Another example is a cable company that matches service jobs to be completed to technicians. The job type and technician skills need to be matched in conjunction with optimizing the assignments. In each of these examples, the enterprise wants to match the availability of assets and the various jobs for which they are needed.

When working with tools that enable distribution of various jobs to be completed among various available workers, especially in large numbers, typically an accurate distance measurement needs to be made between every possible pairing of the jobs. This type of measurement requires finding the exact route between each pair of jobs, e.g., using turn-by-turn directions. This can be a very expensive calculation, and often times is wasteful since many of the pairs of jobs will never be assigned or grouped together because the distance between them is too great.

Accordingly, there is a need in the art for a way to optimize distribution of a set of jobs for execution by available workers in a way that is less costly and avoids calculations between pairs of jobs that are unlikely to be grouped together.

### SUMMARY

In various embodiments, the present invention provides methods and systems for optimizing distribution of jobs for execution among available workers. The method includes receiving job and geographic region data, and establishing distance-based categories for pairs of jobs based on the geographic region data and distance between each pair of jobs. The distance between jobs may be an absolute distance or an estimated distance, and may be based on the precise location of each job in a geographic region or upon the geographical zone, e.g., a portion of a city or metropolitan area, in which each job exists.

Using the distance measurement or estimate, a value is then assigned to each pair of jobs and job schedules and grouping can be made based upon the assigned value. The values allow certain job pairs to be excluded from consideration from grouping together, and emphasize which jobs are best for pairwise assignment. Thus, expensive calculations of precise turn-by-turn directions for every pair of jobs can be eliminated and time is not wasted on jobs that would not be paired because the distance between them is too great.

The description in the specification is not all inclusive and, in particular, many additional features will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is a flowchart illustrating a method of distributing a set of jobs for execution according to one embodiment of the present invention.

FIG. 2 illustrates an example of a chart showing pairwise alignment of five jobs and distances between the pairs of jobs.

FIG. 3A shows an example of a geographic region divided into geographical zones.

FIG. 3B shows an altered version of FIG. 3A, wherein the zones have been adjusted so that zone boundaries are arranged outside of geographical barriers.

FIG. 4 is a block diagram illustrating a job route optimization software application.

FIG. 5 is a block diagram illustrating a possible architecture of a system useful for supporting a job route optimization software application.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

The job route optimization systems and methods described herein enable distribution of various jobs among various available workers, especially in large numbers, e.g., 1,000 jobs among 100 workers. This is the context in which the embodiments are described herein.

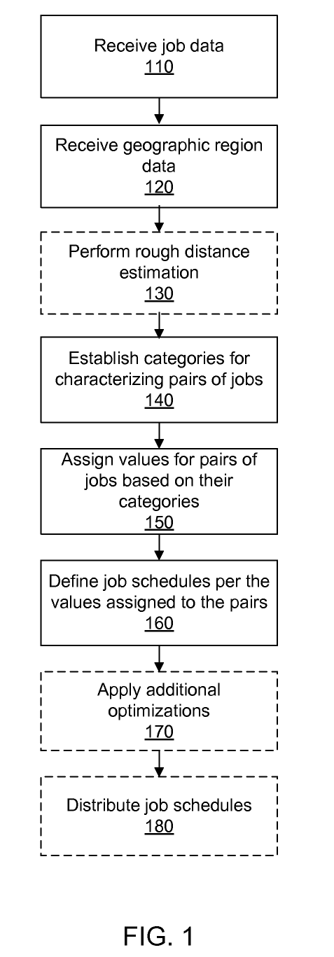

FIG. 1 is a flowchart illustrating a method of optimizing job distribution according to one embodiment of the present invention.

The method begins with a set of jobs for execution by various available workers. Each worker will execute a group of jobs as defined by the method as described herein. Initially, data is received 110 for a set of jobs for execution, including geographic location information for each job. Various additional information about each job may be received, including information about the type of job, the duration of job, a deadline for the job, etc. The jobs may span a geographical area or otherwise have some common elements. The jobs may be of various types.

The geographic location information may include, e.g., an address and/or coordinates for the job location and/or may indicate information about the geographic location within a geographic region. The job data may be received 110 from one or more clients for whom the job distribution is being optimized. Examples of clients include parcel companies with multiple package deliveries to be made by various truck drivers, cable companies with service calls of various types to be made at various locations, and other similar product and/or service providers with multiple jobs to be executed by multiple workers. In some embodiments, the geographic location information may include information about a node associated with each job, for example, with each node corresponding to a particular service office or district, using pre-established nodes provided by the client.

Geographic region data also is received 120 for one or more geographic regions corresponding to the set of jobs. The geographic region data may include information about geographic locations associated with various jobs within the geographic region. The geographic region data may reference a graphical representation of the road system for the geographic region, and/or other travel related information such as speed limits, etc., for use in determining, e.g., actual driving distances and driving times between geographic locations.

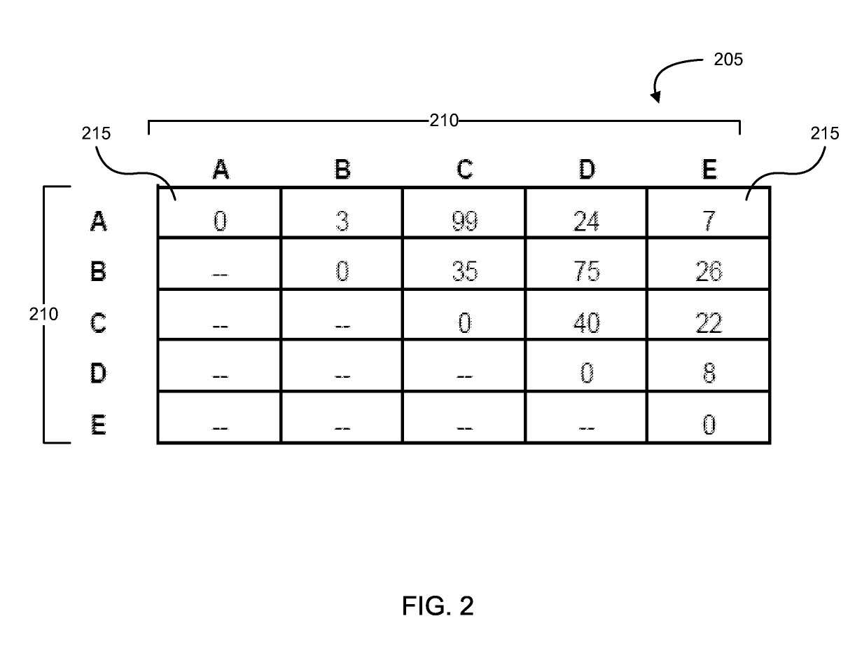

Optionally, a rough distance estimation may be performed 130 using the geographic region data. Initially, all jobs in the set are paired up. In this example, jobs are aligned pairwise and distances between them calculated using standard arithmetic methods. FIG. 2 illustrates an example of a chart 205 for such alignment for five jobs A-E (210). The fields 215 of the chart 205 show the absolute distance (e.g., in miles) between each pair of jobs, at the intersection of the row and column for the pairs.

Next, distance-based categories are established 140 for characterizing pairs of jobs selected from the set of jobs, using the pairs and geographic region data. This step may immediately follow receiving 120 the geographic region data for cases in which the optional rough distance calculation 130 is not made. The number of distance-based categories used varies across different embodiments. For example, there may be three distance-based categories: near, medium, and far. For example, “near” may categorize distances less than some threshold distance (e.g., in miles), “medium” may categorize distances within some range of distances above the threshold distance for “near” distances, and “far” may categorize distances greater than the “medium” range. In other embodiments, more or fewer distance-based categories are used.

According to one embodiment, the distance-based categories are based upon the absolute distances between pairs of jobs. According to another embodiment, the distance-based categories are based upon distances between geographical zones corresponding to the jobs in each pair. The number of distance-based categories and their treatment will vary among the different embodiments.

In the instance of distance-based categories based upon the absolute distances between pairs of jobs, establishing 140 the distance-based categories includes determining the absolute distance between each pair of jobs. Absolute distance, as used herein, is defined as the distance between two points measured using a straight line. Distance-based categories may be established for the job pairs based on the absolute distances, or the absolute distances may fall into pre-established distance-based categories. For example, for the jobs A-E (210) shown in the example of FIG. 2, “near” may be categorized as less than 25 miles, “medium” in the range of 25-50 miles, and “far” for distances greater than 50 miles.

Thus, for the jobs A-E (210), the pairs are categorized in this example as follows:

| Near | Medium | Far |
|---|---|---|
| AB | BC | AC |
| AD | BE | BD |
| AE | CD | |
| CE | | |
| DE | | |

In the instance of distance-based categories based upon distances between geographical zones corresponding to the jobs in each pair, establishing 140 a plurality of distance-based categories includes establishing a set of geographical zones for an area corresponding to the set of jobs, e.g., by dividing a geographic region (e.g., a city) and determining into which geographical zone each job falls. Thus, the distance-based categories in this example may be based upon distances between zones.

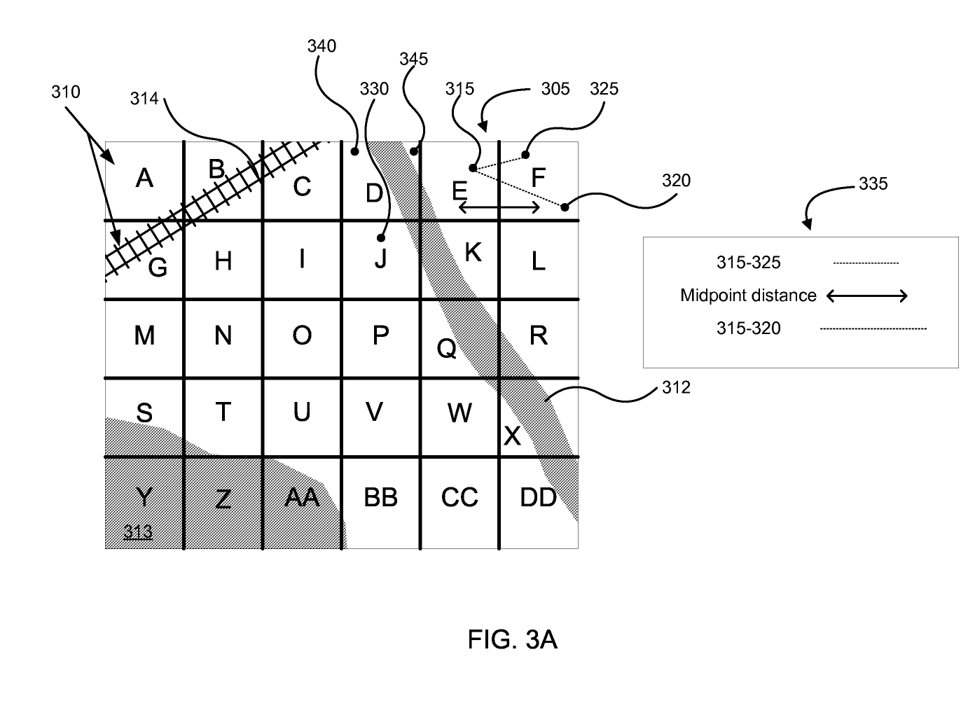

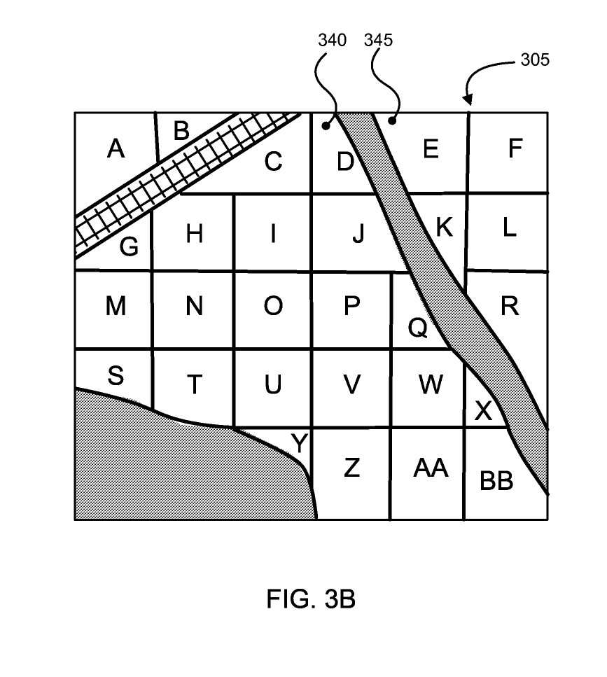

An example of a geographic region 305 divided into geographical zones 310 is shown in FIG. 3A. The geographic region 305 may be a metropolitan area, city, county, or the like. In this example, the geographic region 305 is a city, showing a river 312, a lake 313, and train tracks 314 spanning portions of the city. Thus, distances between pairs of jobs (e.g., between jobs 315, 325) may be calculated based on the distance between the zones E and F (310), instead of between the actual job locations within the zones (e.g., 315, 325). For example, the distance used may be the distance from the center of one zone to the center of another zone. Thus, a job anywhere in a zone 310 has a calculation based on the proximity of the zones 310, regardless of the location of the job within the zone 310. For example, the calculated distance between jobs 315 and 320 and between 315 and 325 (each represented by dotted lines) would be the same even though the actual distances are different, because jobs 320 and 325 both are in the same zone. As shown in side-by-side comparison box 335, the midpoint distance estimate is not a precise measure of the distances between jobs 315 and 320 or between jobs 315 and 325, however, there also is not a significant disparity between the estimate and either actual distance. Thus, using this type of distance estimation an estimate can be made of the distance between jobs.

Alternatively, the distance-based categories may be based on zone proximity. For example, the distance-based categories may include jobs within the same zone, jobs in adjacent zones, and jobs in distant zones (i.e., non-adjacent zones). Different quantities and/or categorization methods may be used in other examples, e.g., using additional categories such as “non-adjacent,” which might characterize zones that are not adjacent, but too close to be “distant.” However, some job pairs may fall into “geographically impeded zones.” Geographically impeded zones, as used herein, are defined as zones that have one or more geographical barriers between them. Thus, geographically impeded zones may be close to each other in actual (absolute) distance between jobs, but may require a greater distance to get from one job to the other. For example, for the jobs shown in FIG. 3A, if the pairs were categorized using only same, adjacent, distant, more than half of the pairs would not reflect an accurate picture of the distance between jobs. Using the jobs shown in FIG. 3A, the jobs fall as follows:

| Same Zone | Adjacent Zones | Distant Zones | Geographically-impeded |
|---|---|---|---|
| 320, 325 | 315, 320 | 320, 345 | 315, 330 |
| (340, 345) | 315, 325 | 325, 345 | 315, 340 |
| | 315, 345 | (320, 330) | 320, 330 |
| | 330, 340 | (320, 340) | 320, 340 |
| | (315, 330) | (325, 330) | 325, 330 |
| | (315, 340) | (325, 340) | 325, 340 |
| | (330, 345) | | 330, 345 |
| | | | 340, 345 |

In the table above, job pairs in parenthesis indicate job pairings if only same, adjacent, distant categories were used, and italicized pairings show those that for which these categorizations would not reflect an accurate picture of the actual (e.g., driving distance) distance between job pairs.

For example, note that jobs 340 & 345, although within the same zone (D), also are geographically impeded, in this example, by a river 312. Thus, a simple division of an area into zones 310 as shown and establishment of categories based on the zones 310 may not suffice under all circumstances to delineate distances between jobs for areas with one or more geographical barriers resulting in geographically impeded zones. “Geographical barriers,” as used herein, are geographical aspects that impede travel, e.g., rivers, lakes, railroad tracks, etc.

To accommodate for these geographical barriers, the set of geographical zones 310 may be established such that the borders of the zones 310 are selected to avoid geographical barriers between locations within each zone. FIG. 3B shows an altered version of FIG. 3A, wherein the zones 310 have been adjusted so that zone boundaries are arranged outside of geographical barriers. For example, FIG. 3B shows zones D and E bounded by the river 312, emphasizing the geographical barrier between them, and thus job 345 now is in zone E (instead of in zone D as shown in FIG. 3A). As a result, geographically impeded zones 310 can be more readily identified and job pairings adjusted accordingly. Similar calculations of distances between jobs using the zone midpoint distance discussed above can be used with the zone border model of FIG. 3B. Alternatively, an additional category “geographically impeded zones” could be used. Thus, in these various examples, jobs are aligned pairwise and categories for the pairs of zones are established.

Referring again to FIG. 1, once distance-based categories are established for the pairs of jobs by any of the various methods described above, a value is assigned 150 to each pair based on its distance-based category. The assigned value can vary from a very precise value, e.g., for a distance measured using turn-by-turn directions between jobs, to an assigned value, e.g., an estimate or a selected value, or can be any value in between.

For example, the value assigned to each pair may be selected from the group consisting of a very high value, an estimated value, and a precise value according to one embodiment. A precise value would be assigned, for example, only to pairs of jobs that are very near in proximity, e.g., jobs in the same or adjacent zones using the examples above. This would allow for a precise calculation of distances for the exact distance between these jobs, e.g., using turn-by-turn directions. In this example, a precise value indicates that a pair of jobs is close in proximity and/or actual travel time between jobs is small, and thus the pair is a good candidate for execution together. A very high value may be assigned, for example, to pairs of jobs that are too far apart to feasibly be executed together. This provides an indication that there is no need to do the (often expensive) computation of distance using turn-by-turn directions, as these are not good jobs for grouping. Examples of very high values that may be assigned to these pairs are infinity, 5,000 miles, or some other large distance to indicate that the jobs are too distant to be considered for execution as a pair. One example is the geographically impeded job pairs discussed above; if a geographical barrier exists between the jobs, then those jobs are unlikely to be executed together, even if the absolute distance between them is small. An estimated value may be assigned, for example, to pairs of jobs that are neither very near in proximity, nor too far apart to be grouped together. For these jobs, the estimated value may be based upon how many zones separate the pair of jobs; for example, if a value of 5 miles is assigned per zone, then jobs in zones spanning four zones, e.g., zones C to U in FIG. 3A, would be assigned 20 miles.

Tying in this model with the distance-based categories above, in one example for pairs for which the distance-based category is far, the value assigned is a very high value, for pairs for which the distance-based category is medium, the value assigned is an estimated value, and for pairs for which the distance-based category is near, the value assigned to each pair is a precise value. In another example, jobs for which the distance-based category is within the same zone or in adjacent zones are assigned a precise value, for pairs for which the distance-based category is distant zones, the value assigned is an estimated value, and for jobs for which the distance-based category is geographically impeded zones, the value assigned is a very high value.

Based upon the values assigned to the pairs of jobs, the jobs can more easily be grouped into lists defining 160 a job schedule for execution by the various available workers. For example, using the jobs shown in FIG. 3A, jobs 315, 320, and 325 might logically be grouped, since each pair among the three jobs would be characterized as near in the above example. Similarly, jobs 330 and 340 may be so grouped. Using the distance-based category and assigned value information, a set of jobs (e.g., 1,000 jobs to be shared by 100 workers) may more easily be organized so as to optimize the groupings most efficiently based on, e.g., total travel time and/or total distance traveled.

In some instances, additional optimizations may be applied 170 to the job schedules. This step is optional, as indicated by the dotted lines surround this step. For example, using information about the type of job, the skills required for the particular job, space constraints on a delivery truck, how long the job will take, etc., additional optimizations may be determined and applied to the job schedules to produce a final job schedule for each worker. The job schedule defining 160 and/or additional optimizing 170 steps above may be performed by an outside vendor and/or additional software according to one embodiment, and then applied.

Optionally, the final job schedules may be distributed 180 and/or stored. The job schedules may be distributed to one or more clients, or to the workers directly in one embodiment. Alternatively, or in addition to distributing the job schedules, the job schedules may be stored for later distribution and/or for later reference.

These aspects of the present invention allow certain job pairs to be excluded from consideration from grouping together, and emphasize which jobs are best for pairwise assignment. Thus, expensive calculations of precise turn-by-turn directions for every pair of jobs can be eliminated and time is not wasted on jobs that would not be paired because the distance between them is too great. The lists then may be stored and/or distributed 180 (e.g., for execution), if desired.

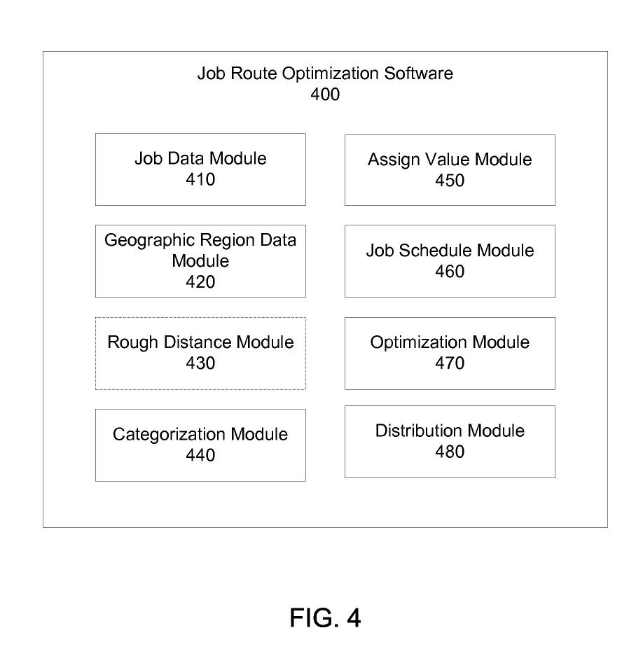

As shown in FIG. 4, a job route optimization software application 400 is comprised of a number of executable code portions and data files. These include code for executing the method of distributing a set of jobs for execution as described herein. In some embodiments, the job route optimization software application 400 can be implemented as a stand-alone application. In other embodiments, it may be part of a asset management platform as discussed further below.

The job route optimization software application 400 is responsible for orchestrating the processes performed according to the methods of the present invention. The job route optimization software application 400 includes a job data module 410, a geographic region module 420, an optional rough distance module 430, a categorization module 440, an assign value module 450, a job schedule module 460, and an optimization module 470, and a distribution scheduling module 480 according to one embodiment of the present invention.

The job data module 410 enables receiving of data for a set of jobs for execution, including geographic location information for each job according to one embodiment. The job data may be received from one or more clients for whom the job distribution is being optimized.

The geographic region module 420 enables geographic region data to be received for one or more geographic regions corresponding to the set of jobs according to one embodiment. The geographic region data may include information about geographic locations associated with various jobs within the geographic region.

The optional rough distance module 430, if included, enables a rough distance estimation to be performed for each pair of jobs using the geographic region data according to one embodiment. The rough distance module 430 may be further configured to pair up all the jobs in the set and align the jobs pairwise and calculate the distances between them.

The categorization module 440 enables establishing a plurality of distance-based categories for characterizing pairs of jobs selected from a set of jobs according to one embodiment. The distance-based categories may be based upon the absolute distances between pairs of jobs, distances between geographical zones corresponding to the jobs in each pair, or some other measurement. The categorization module 440 may be further configured to pair up all the jobs in the set and align the jobs pairwise and calculate the distances between them if a rough distance module 430 is not present.

The assign value module 450 enables assignment of a value to each pair based on its distance-based category according to one embodiment. The assigned value can vary from a very precise value, e.g., for a distance measured using turn-by-turn directions between jobs, to an assigned value, e.g., an estimate or a selected value, or can be any value in between.

The job schedule module 460 enables the jobs to be more easily be grouped into lists for execution by the workers according to one embodiment. Thus, using the distance-based category and assigned value information, a large set of jobs may more easily be optimized.

The optimization module 470 enables additional optimizations optionally to be applied to the job schedules according to one embodiment. For example, using information about the type of job, the skills required for the particular job, space constraints on a delivery truck, how long the job will take, etc., additional optimizations may be determined and applied to the job schedules to produce a final job schedule for each worker.

The distribution module 480 enables final job schedules to be distributed and/or stored according to one embodiment.

The above software portions 410-480 need not be discrete software modules. The software configuration shown is meant only by way of example; other configurations are contemplated by and within the scope of the present invention.

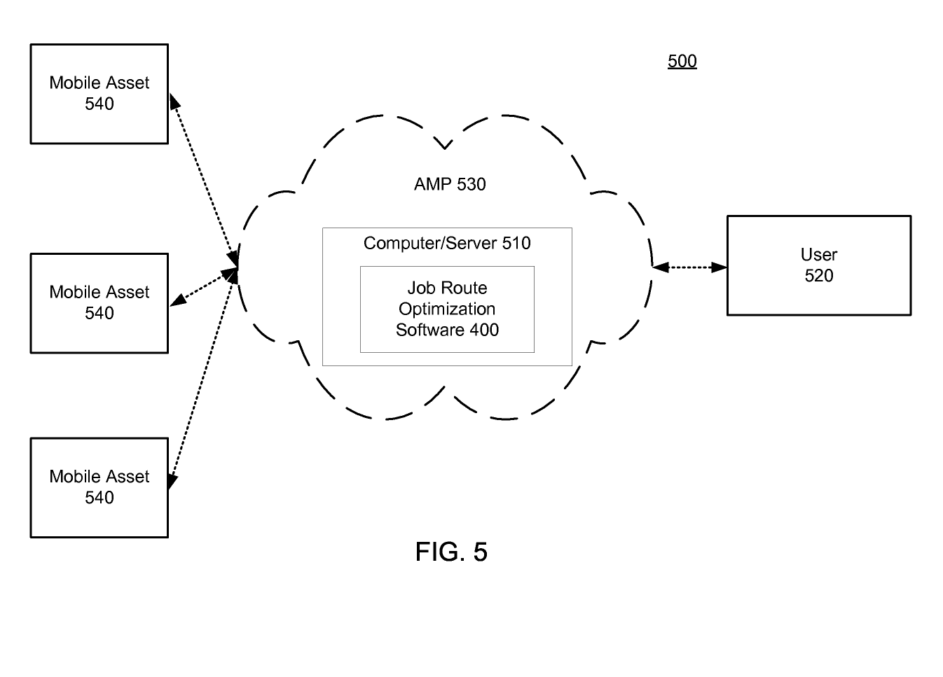

FIG. 5 is a block diagram illustrating the architecture of one embodiment of a system 500 useful for supporting a job route optimization software application 400 for executing the method of distributing a set of jobs for execution as described herein.

The job route optimization software application 400 may reside within a computer/server 510. The job route optimization software application 400 may be provided to the computer/server 510 on a computer readable media, or by electronic communication over a network from a software distributor, for installation and execution thereon. Alternatively, the job route optimization software application 400 may be hosted on a computer/server 510, and accessed over a network by a user 520, using for example a browser or other user interface to the job route optimization software application 400.

The computer/server 510 may be a stand-alone device or may be communicatively coupled to a network and/or one or more other computers, e.g., a user computer 520. The computer/server 510 may be of conventional computer system design, and includes a processor, an addressable memory, and other conventional features (not illustrated) such as a display, local memory, input/output ports, and a network interface. In other embodiments, the computer/server 510 is a high performance server class computer. The details of the hardware aspects of servers are well known to those of skill in the art and are not further described herein. The computer/server 510 is depicted in FIG. 5 as a single computer/server 510, however the system alternatively may be implemented as multiple (logically or physically) devices, or as a network of computer processors and associated storage devices. Examples of computer/server devices 510 include servers, mainframe computers, networked computers, a processor-based device, and similar types of systems and devices. The computer/server 510 processor can be any of a number of well known computer processors, such as processors from Intel Corporation of Santa Clara, Calif. and Motorola Corporation of Schaumburg, Ill. The computer/server 510 has sufficient processing power and bandwidth to perform the job optimization functions described herein.

In one embodiment, the server/computer 510 optionally is part of, or is coextensive with an asset management platform (AMP) 530, as indicated by dotted lines around the AMP 530. The AMP 530 may provide communications between various mobile assets 540 and users 520. In one embodiment, the AMP provides an intelligent, articulated, and configurable platform for performing fleet management and other asset tracking functions, as described in co-pending U.S. application Ser. No. 10/412,594, entitled “Asset Management Platform,” filed on Apr. 8, 2003, which is hereby incorporated by reference in its entirety.

A mobile asset 540 is a thing that communicates with the computer/server 510 or by the AMP 530, e.g., to receive distribution of grouped jobs for execution as described herein. Examples of mobile assets include cars, trucks, ships, laptop and desktop computers, people, animals, packages, clothing, fine art, luggage, etc. For example, a mobile asset 540 may be a vehicle associated with a worker that has been distributed a job schedule as described herein. The asset 540 need not be mobile at any given instance in time; in fact, some assets may be stationary for extended periods of time or not generally thought of as “mobile.” Accordingly, this description uses the phrase “mobile asset” to refer to both mobile and immobile assets. Only three mobile assets 540 are illustrated in FIG. 5 for purposes of clarity. However, typical environments can have any number of mobile assets 540.

The end-user 520 illustrated in FIG. 5 is representative of a person, computer system, application, or other entity that communicates with the computer/server 510 or AMP 530 to access the job optimization functionalities described herein. The computer/server 510 and/or AMP 530 and end-user 520 can communicate via a variety of technologies and interfaces. For example, using a telephone-based interactive voice response (IVR) interface, a web page-based interface, an email interface, data exchanged via a network connection utilizing the transmission control protocol/Internet Protocol (TCP/IP), and/or a dedicated application interface. The end-user 520 can utilize a variety of devices to access these interfaces, including a telephone, computer system, pager, etc. These communications can utilize conventional wired and/or wireless data and/or voice communications links. Although only one end-user 520 is shown in FIG. 5, embodiments of the system 500 have many end-users 520. The end-user 520 may be a client, e.g., that provides job data as described herein according to one embodiment.

One skilled in the art will recognize that the system architecture illustrated in FIG. 5 is merely exemplary, and that the invention may be practiced and implemented using many other architectures and environments.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A method of optimizing job distribution, comprising:
receiving data representative of the set of jobs for execution, each job occurring at a geographic location within a geographic region;
receiving data corresponding to the geographic region, comprising data corresponding to each geographic location within the geographic region;
establishing a plurality of distance-based categories for characterizing pairs of jobs using the data corresponding to the geographic region, the pairs selected from the set of jobs for execution;
assigning a value, for each pair of jobs, based on a distance-based category corresponding to the pair; and
defining a job schedule grouping the jobs of the set for execution based upon the values assigned to the pairs of jobs and each geographic location, wherein each group comprises a list of jobs for serial execution.

2. The method of claim 1, wherein the distance-based categories are based upon absolute distances between jobs of each pair.

3. The method of claim 1, wherein the distance-based categories are based upon distances between geographical zones for the jobs in each pair.

4. The method of claim 1, wherein:
establishing a plurality of distance-based categories further comprises:
establishing a set of geographical zones for an area corresponding to the set of jobs;
assigning selected of the plurality of distance-based categories to each pair of zones; and
wherein establishing a value for each pair is based on the distance-based category assigned to each pair of zones.

5. The method of claim 4, wherein the set of geographical zones comprise borders selected to avoid geographical barriers between locations within each zone.

6. The method of claim 1, wherein establishing a plurality of distance-based categories further comprises:
calculating distances between each of the pairs of jobs;
assigning each pair one of the plurality of distance-based categories based upon the calculated distance; and
wherein establishing a value for each pair is based on the distance-based category assigned to each pair of zones.

7. The method of claim 1, wherein the value assigned to each pair is selected from the group consisting of a very high value, an estimated value, and a precise value.

8. The method of claim 7, wherein the very high value indicates that a selected pair of jobs are too far apart to be a part of a group.

9. The method of claim 7, wherein the estimated value indicates an approximate distance between a selected pair of jobs.

10. The method of claim 7, wherein the precise value indicates a turn-by-turn distance calculation between a selected pair of jobs.

11. The method of claim 1, wherein the distance-based categories comprise far, medium, and near.

12. The method of claim 11, wherein:
for pairs for which the distance-based category corresponding to the pair is far, the value assigned to each pair is a very high value;
for pairs for which the distance-based category corresponding to the pair is medium, the value assigned to each pair is an estimated value; and
for pairs for which the distance-based category corresponding to the pair is near, the value assigned to each pair is a precise value.

13. The method of claim 1, further comprising distributing the lists for execution.

14. The method of claim 1, wherein the plurality of distance-based categories are established taking into account one or more geographical barriers.

15. The method of claim 1, further comprising distributing the lists for execution.

16. A computer program product for optimizing job distribution, the computer program product comprising:
a computer-readable medium; and
computer program code, coded on the medium, for:
receiving data representative of the set of jobs for execution, each job occurring at a geographic location within a geographic region;
receiving data corresponding to the geographic region, comprising data corresponding to each geographic location within the geographic region;
establishing a plurality of distance-based categories for characterizing pairs of jobs using the data corresponding to the geographic region, the pairs selected from the set of jobs for execution;
assigning a value, for each pair of jobs, based on a distance-based category corresponding to the pair; and
defining a job schedule grouping the jobs of the set for execution based upon the values assigned to the pairs of jobs and each geographic location, wherein each group comprises a list of jobs for serial execution.

17. The computer program product of claim 16, wherein:
the computer program code coded on the medium for establishing a plurality of distance-based categories is further configured for:
establishing a set of geographical zones for an area corresponding to the set of jobs;
assigning selected of the plurality of distance-based categories to each pair of zones; and
wherein establishing a value for each pair is based on the distance-based category assigned to each pair of zones.

18. The computer program product of claim 17, wherein the set of geographical zones comprise borders selected to avoid geographical barriers between locations within each zone.

19. The computer program product of claim 16, wherein the computer program code coded on the medium for establishing a plurality of distance-based categories is further configured for:
calculating distances between each of the pairs of jobs;
assigning each pair one of the plurality of distance-based categories based upon the calculated distance; and
wherein establishing a value for each pair is based on the distance-based category assigned to each pair of zones.

20. The computer program product of claim 17, wherein:
for pairs for which the distance-based category corresponding to the pair is far, the value assigned to each pair is a very high value;
for pairs for which the distance-based category corresponding to the pair is medium, the value assigned to each pair is an estimated value; and
for pairs for which the distance-based category corresponding to the pair is near, the value assigned to each pair is a precise value.
